(19) United States
(12) Patent Application Publication
(10) Pub. No.: US 2007/0038834 A1
(43) Pub. Date: Feb. 15, 2007

(54) Method and System for Managing the Sending of Data Packets Over a Data Path

(76) Inventors: Rolf Fritz, Waldenbuch (DE); Andreas Koenig, Leonberg (DE); Susan Marie Rubow, Hyde Park, NY (US); Christopher Smith, Tanun (DE); Gerhard Zilles, Jettingen (DE)

Correspondence Address: INTERNATIONAL BUSINESS MACHINES CORPORATION, IPLAW DEPARTMENT, 2455 SOUTH ROAD - MS P386, POUGHKEEPSIE, NY, 12601, US

(21) Appl. No.: 11/458,458

(22) Filed: Jul. 19, 2006

(30) Foreign Application Priority Data
Jul. 25, 2005 (EP) 05106815.3

(51) Int. Cl. G06F 13/28; G06F 12/00; G06F 13/00

(52) U.S. Cl. 711/169

(57) ABSTRACT

The present invention relates to a method, and a respective system, and computer program product for sending data packets along a predefined data path, wherein the receipt of a packet is acknowledged within a predefined time delay that was preset and tuned according to the duration of the send process via said data path. Packets that were sent along the data path are also entered into a pipeline. The pipeline is tuned to have a depth of a predetermined number of clock cycles that correlates to the predefined time delay for the receipt of an acknowledgement message. For a packet in the output registers of the pipeline it is checked if an acknowledge message for the packet was received. Otherwise the packet will be sent again. Especially, the pipeline can be used as a bus trace vehicle.

### BACKGROUND OF THE INVENTION

1. Field of the Invention

The present invention relates to computer technology and in particular to a method, system, and a computer program product for sending data packets along a predefined data path, wherein the receipt of the data is acknowledged within a predefined time delay preset and tuned according to the duration of the send process via said data path.

2. Description and Disadvantages of Prior Art

An example of a data path is a bus system. A prior art bus system of a high-performance server computer is schematically depicted in FIG. 1. An arbiter 10 arbitrates a plurality of buffers 12 with different packets emerging at its input port in a respective inbound stream 8. Due to increased performance requirements there is a need to provide enough buffers to allow a back-to-back traffic on the outbound stream 16. A selector 14 comprises a logic which selects the contents of a respective buffer 12 for transmission to the respective target device as indicated in a data packet.

Disadvantageously, the packets emerging at the input have different lengths.

Thus, prior art buffer mechanisms require as many buffers as packets can be in the worst case on the roundtrip between sender and receiver including the return direction. The current bus architecture including those buffers 12 have some problems:

First an implementation of a sufficient number of buffers with appropriate size results generally in a significant waist of buffer space as in the average case of statistical averaging, the buffer space is not used efficiently. If the number of buffers, however, is restricted due to a predefined buffer saving approach, then a considerable lack of performance may result in situations in which the number of packets on the round trip is high. Further, disadvantageously an additional space is needed in order to support a storage of bus data trace information, and finally, a support of streaming technology is needed which may be implemented with the buffer-based mechanisms of prior art only by tolerating complicated implementations. This is due to the fact that the buffer implementation needs complex buffer arbitration as the input stream is received in serialized form, must be broken up, in order to be able to be buffered in parallel buffers, and must be re-ordered and re-serialized from the parallel buffered stream portions in order to obtain the same serialized form at the output port as it was present at the input port.

### OBJECTIVES OF THE INVENTION

It is thus an objective of the present invention to provide a method according to the preamble of claim 1 and a respective system which uses storage space more efficiently.

### SUMMARY AND ADVANTAGES OF THE INVENTION

This objective of the invention is achieved by the features stated in enclosed independent claims. Further advantageous arrangements and embodiments of the invention are set forth in the dependant claims. Reference should now be made to the appended claims.

According to a basic feature of the present invention it is proposed to use a pipe instead of the plurality of the before-mentioned buffers 12, wherein the pipe is used for both, temporarily storing the data packets and for providing an exact timing of the processing of the acknowledgement messages sent by the receiver, in order to avoid a complicated selection logic when reading from the buffers in prior art. In this aspect the pipe involves a predefined delay which coincides with the round trip delay mentioned before.

In other words, in a method for managing the sending of information packets over a bus path to a receiver unit which issues an acknowledgement message of the receipt of said information packets after a predetermined first number of clock cycles, it is proposed to perform the following steps:
a) entering (430) the packets into a pipeline (20) tuned to have a depth of a predetermined second number of clock cycles,
b) determining the time relation between said first and second number of clock cycles, e.g., roundtrip=9 cycles; and pipeline depth=7 cycles+2 cycles offset; or preferably: roundtrip=9 cycles; and pipeline depth=9 cycles+0 cycles offset;
c) wherein said entering is done at an entering time obtained by calculating from said time relation,
d) observing (460) the output registers of the pipeline (20) and the input registers for receiving the acknowledgement message including said time relation,
e) retrying (480, 490, 495) a send process for the packet present in the output register of the pipeline (20), when said time-related acknowledge message at said related time.

As the pipeline has enough storage space for receiving the mostly occurring data packets and should be designed to receive a plurality of data packets in average size, the content of the pipeline immediately reflects the order in which the packets were sent. By that, a bus trace implementation is provided. By that the individual length of a data packet has no more the significant relevance for data management as it had in prior art. Similarly, the mixed combination of packets which were distributed in prior art across the plurality of buffers is of reduced significance only.

At the output registers of the pipe a filter function is implemented which processes the exactly timed acknowledgement signal from the recipient of the data packet and filters out all those data packets to which no acknowledgement exists. Those packets are stored in a separate queue from which the packets are fed with a relatively high priority to the before-mentioned arbitration unit.

### BRIEF DESCRIPTION OF THE DRAWINGS

The present invention is illustrated by way of example and is not limited by the shape of the figures of the drawings in which:

FIG. 1 is a schematic block diagram representation of prior art bus management;

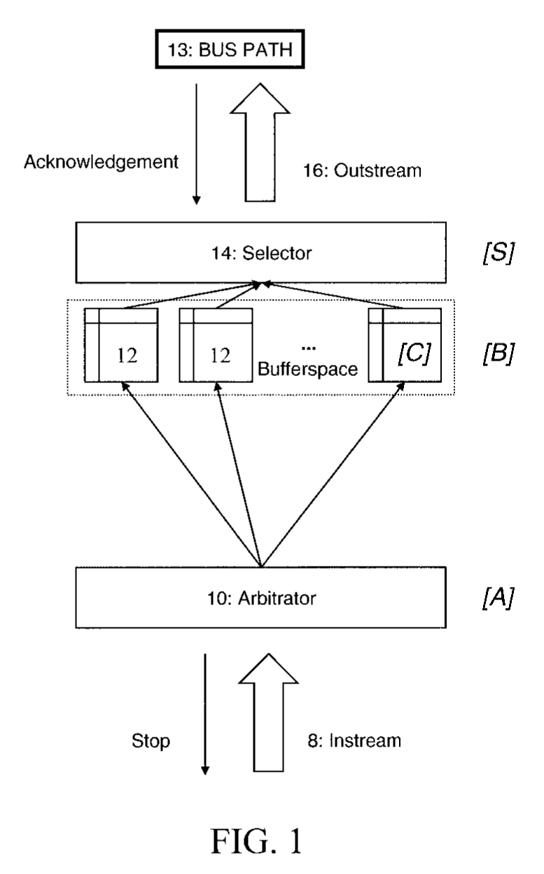

FIG. 2 is a schematic block diagram representation illustrating the basic structural elements implemented according to a preferred embodiment of the invention in an overview form;

FIG. 3 is a depiction of FIG. 2 in a more detailed form;

FIG. 4 is a control flow diagram illustrating the control steps in a preferred embodiment of a method in accordance with the invention;

FIG. 5 is a control flow diagram illustrating the control flow of the pointer calculation for the pipeline in a preferred embodiment of a method in accordance with the invention.

### DETAILED DESCRIPTION OF THE PREFERRED EMBODIMENT

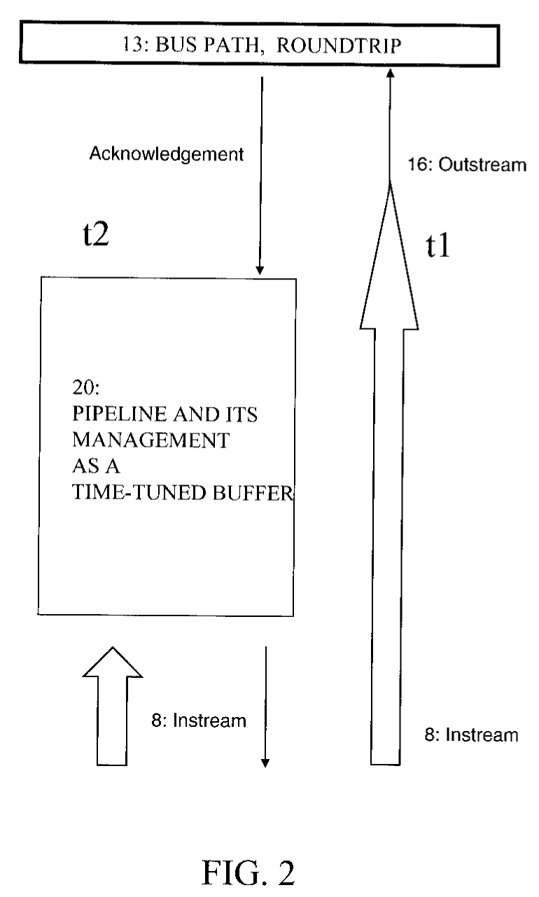

With general reference to the figures and with special reference now to FIG. 2, the data packets denoted as “Instream” 8 are immediately sent at a time t1 to the receivers via the bus system. The packets are usually received by the addressed unit, which then sends back an acknowledgement message received in turn at time t2 at the pipeline control logic—for simplicity shown all included in pipe 20. This way, a roundtrip is defined as a time delay td=(t2−t1). Preferably, this delay is measured in cycle times. Typical values for the delay are in the range of 9 cycles to 13 cycles.

Concurrently, according to the invention, the stream is input into the input registers of a pipeline. Then, a predetermined number of cycles pass and an acknowledgement message is received which was issued from the receiving unit. The pipeline is dimensioned exactly such that at this moment when the acknowledgement is received the respective pipeline entry has completed to walk through the pipeline. Thus, a dedicated logic decides not to initiate a repetition of the sent process of the respective packet if the acknowledgement is received. Otherwise the packet is resent when emerging at the output registers of the pipeline.

It should be added that also—more generally—a fixed relationship other than “concurrently” can be tuned in order to comply with further constraints emerging when the invented method is applied in various corners of a computer system. For example: td+2 cycles, td+4 cycles, etc.

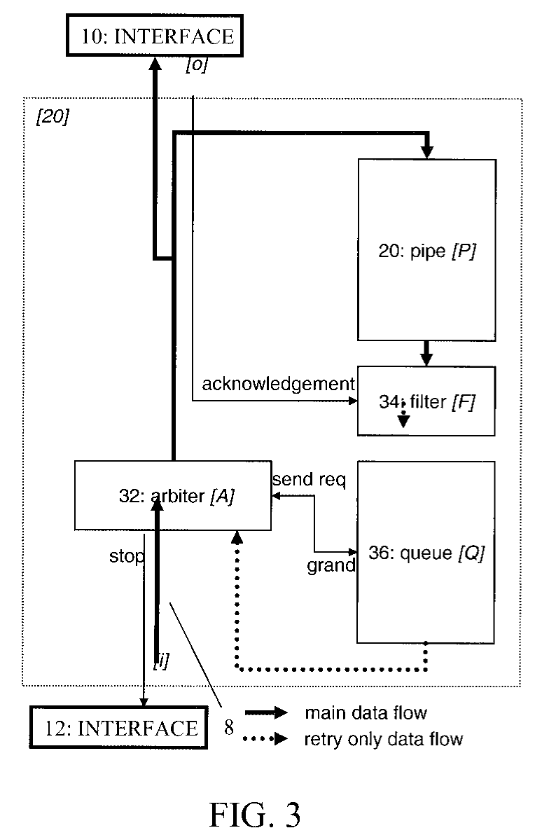

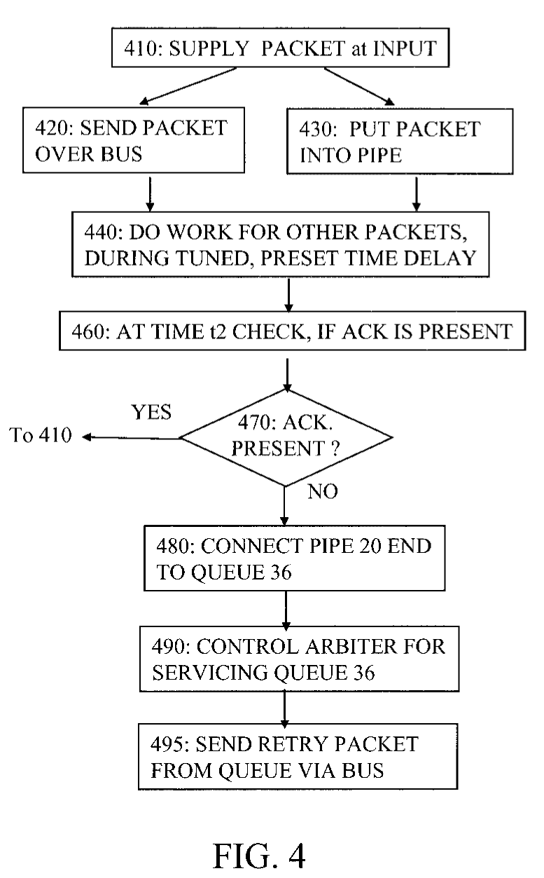

With further reference to FIGS. 3 and 4 more details are given on the pipeline mechanism shown in FIG. 2.

The circuit 20 solves the above described problem in the following way:

An Input Interface 12 supplies a packet stream 8 acting as input stream, step 410. An arbiter 32 arbitrates this stream with a relatively low priority to an Output Interface [o] 10 for sending it over the bus, step 420. Simultaneously, the stream is written into the input port of the pipe 20, step 430. Pipe 20 is dimensioned such that it has exactly the depth of the roundtrip of the packet send process. In the meantime of the roundtrip for the currently sent packet, the pipe control does similar work as it has done for other packets. Then, in steps 460, 470, a filter 34 filters out commands that were not acknowledged, by performing a simple check whether the acknowledge message matches a packet start.

As pipeline 20 depth and the roundtrip delay has to be tuned according to this embodiment to be preferably the same number of cycles, when the acknowledgement message is expected to be received, then exactly the output registers of the pipe 20 contains the header of the packet which was sent and is related to the actually arriving acknowledgement message.

In case no acknowledgement is received, i.e., the retry case, the filter logic 34 sends the stream to a queue 36, step 480. As soon as there is at least a single valid data shot in queue 36, it sends out a send request to the arbiter 32, to control the arbiter to take the next send data from the queue 36 with a high priority, step 490.

It should be noted that the queuing 36 as a mechanism per se is needed to ensure that the low priority inbound stream does not need to be interrupted when it is desired to prefer the high priority retry stream. The mechanism of this queuing 36 is not a focused part of this invention.

This request has a high priority and the arbiter 32 switches to the queue 36, of which the output registers will be read out. Thus, the retry of the packet send process is initiated and performed, step 495.

In the YES branch of decision 470, i.e., when the packet receipt was acknowledged successfully, then the control is fed back to step 410 for processing the sending of the next packet.

If there is no longer a request from the queue 36, the arbiter switches back to the Input Interface 12 to continue the data transfer in order to continue the regular send process.

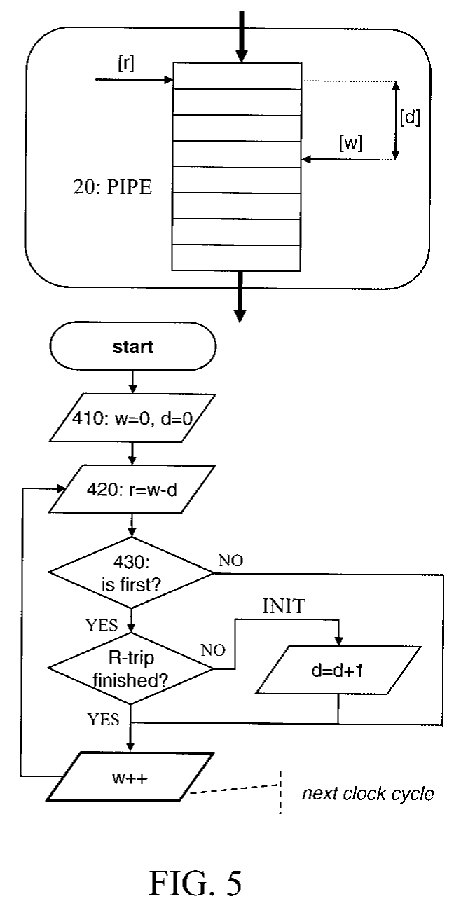

FIG. 5 shows more details of the control logic required for the pointer calculation in this mechanism of FIG. 3.

The pipeline 20 has a read pointer [r] and a write pointer [w]. Those pointers are depicted with respective arrows at symbolic positions in the pipe entry sequence. The distance d is the number of entries between write pointer and read pointer. At an initialisation step the read pointer and the write pointer are set preferably to the same pipe entry location at the input end of the pipe.

When the first packet arrives in the pipe 20, w is increased and also is [d]. So the distance between [w] and [r] increases with each cycle, as long as the packet roundtrip is not finished. Assume a roundtrip delay of 60 cycles. With the 60^{th} cycle the roundtrip is finished.

Distance [d] is handled as a constant until the pipe is reset. Since the protocol requires that the round trip delay is fixed for all packets the pipe delays the packet exactly until the roundtrip is finished.

This logic is depicted in the bottom part of FIG. 5. The “INIT” branch is run through only once for an initialization in order to get the correct value for the time delay on the bus system, as this is specific for each computer system.

The filter logic initiates w and d to zero values in step 410. Then, in step 420 the read pointer is set to the location r=w−d. This is at the beginning the same location. Then a decision 430 is evaluated, if the packet is “the first” packet, which means that a packet is sent for measuring the before-mentioned delay and presetting the delay “td” to this value. If YES, this means a single initialization loop cycle is run through using a test packet send process. As long as the test packet is not yet acknowledged the parameters d and w are increased by 1 in each cycle.

After the Acknowledgment message is received, this delay is determined and the “is first” condition will be always evaluated to FALSE.

Then read and write pointer have the desired distance from each other in order to read from and write into the pipe 20 correctly.

The present invention can be realized in hardware, or in a combination of hardware and software as implemented in ASIC. Any kind of computer system or other apparatus adapted for carrying out the methods described herein is suited.

The present invention can also be embedded in a computer program product such as an ASIC, or FPGA, which comprises all the features enabling the implementation of the methods described herein, and which—when installed in a computer system—is able to carry out these methods.

Computer program means or computer program in the present context mean any expression, in any language, code or notation, of a set of instructions intended to cause a system having an information processing capability to perform a particular function either directly or after either or both of the following
a) conversion to another language, code or notation;
b) reproduction in a different material form.

1. A method for managing the sending of a data packet from a sender unit to a receiver unit over a data path, wherein said receiver unit returns an acknowledgement message of the receipt of said data packet after a predetermined first time delay, and said sender unit comprises a pipeline which can process said data packet in a predetermined second time delay,
the method being characterized by the steps of:
determining the time relation between said first and said time delay;
creating a copy of said data packet;
entering said copy into said pipeline after said data packet was sent to said receiver unit at an entering time depending on said time relation such that said copy will be released by said pipeline at the same time when said acknowledgement message has to be received;
sending said copy to said receiver unit when said copy was released by said pipeline and said acknowledge message was not received.

2. The method according to claim 1, wherein said time relation is defined such that said copy is entered in said pipeline at the same time when said data packet is sent to said receiver unit.

3. The method according to claim 1, wherein in a preprocessing step said first time delay is measured with a send process of a test data packet.

4. A computer system having a bus interface for managing the sending of data packets over a bus path to a receiver unit, which issues an acknowledgement message of the receipt of said data packets after a predetermined first number of clock cycles, characterized by comprising a pipeline buffer having a depth which stands in a fixed, preset time relation to the time delay measured for a roundtrip of an information packet over the bus path.

5. A computer program product stored on a computer usable medium comprising a functional component for causing a computer to perform the method of claim 1, when said computer program product is executed on a computer.
